(19) United States
(12) Patent Application Publication
(10) Pub. No.: US 2020/0323043 A1
(43) Pub. Date: Oct. 8, 2020

(54) HEATED REINFORCEMENT BARS AND ASSOCIATED LAMINATES

(71) Applicant: David Fortenbacher, Muskegon, MI (US)

(72) Inventor: David Fortenbacher, Muskegon, MI (US)

(21) Appl. No.: 16/833,528

(22) Filed: Mar. 28, 2020

Related U.S. Application Data
(63) Continuation-in-part of application No. 15/295,311, filed on Oct. 17, 2016, now Pat. No. 10,644,364.
(60) Provisional application No. 62/827,013, filed on Mar. 30, 2019.

(51) Int. Cl. H05B 3/48; B32B 7/12; B32B 15/20; B32B 15/085; H05B 1/02; H05B 3/14; H05B 3/18; E04C 5/07

(52) U.S. Cl. CPC H05B 3/48; B32B 7/12; B32B 15/20; B32B 15/085; H05B 1/023; H05B 3/145; H05B 2203/016; E04C 5/07; B32B 2255/06; B32B 2255/205; B32B 2264/10; B32B 2307/302; H05B 2214/04; H05B 3/18

(57) ABSTRACT

Heated reinforcement bars and associated laminates are provided. More particularly, the present disclosure relates to heated reinforcement bars and associated laminates that include carbon nanotube heating elements.

### CROSS REFERENCE TO RELATED APPLICATIONS

The present application claims priority to U.S. Provisional Patent Application Ser. No. 62/827,013, filed Mar. 30, 2019, entitled HEATED REINFORCEMENT BARS AND ASSOCIATED LAMINATES, the entire disclosure of which is incorporated herein by reference thereto.

The present application is a continuation-in-part of U.S. patent application Ser. No. 15/295,311, filed Oct. 17, 2016, entitled SELF-HEATING CELLS AND SELF-HEATING BATTERIES INCLUDING THE SELF-HEATING CELLS, the entire disclosure of which is incorporated herein by reference thereto.

### TECHNICAL FIELD

The present disclosure relates to heated reinforcement bars and associated laminates. More particularly, the present disclosure relates to heated reinforcement bars and associated laminates that include carbon nanotube heating elements.

### BACKGROUND

Reinforcement bars are often incorporated into concrete structures (e.g., vertical structures, horizontal structures, concrete driveways, concrete sidewalks, etc.). While known reinforcement bars may include electrically conductive materials (e.g., iron, steel, etc.), the known reinforcement bars are not designed to purposely conduct electricity to produce heat.

In fact, when electricity passes through known reinforcement bars, the reinforcement bars are subject to increased corrosion. Corrosion is even more prevalent when the reinforcement bars are imbedded in concrete.

The above-mentioned known reinforcement bars are not adapted to generate heat when installed. Therefore, there exists a need for improved reinforcement bars and associated laminates.

### SUMMARY

A heated reinforcement bar may include a laminate heating element that includes nanoparticles. The heated reinforcement bar may further include a positive electrical connection and a negative electrical connection. The positive electrical connection and the negative electrical connection may be configured to connect the nanoparticles to an electric power source.

In another embodiment, a laminate heater may include a heat generating portion having nanoparticles deposited on a first surface of a substrate and a pressure sensitive adhesive on a second surface of the substrate. The laminate may further include a positive electrical connection and a negative electrical connection. The positive electrical connection and the negative electrical connection may be configured to connect the nanoparticles to an electric power source.

In a further embodiment, a heated reinforcement bar may include a heating element that includes nanoparticles. The heated reinforcement bar may further include a positive electrical connection and a negative electrical connection. The positive electrical connection and the negative electrical connection may be configured to connect the nanoparticles to an electric power source.

### BRIEF DESCRIPTION OF THE FIGURES

FIG. 1 depicts a heated reinforcement bar;

FIG. 2 depicts a plan view of an example nanoparticle laminate heater;

FIG. 3 depicts a profile view of an example nanoparticle laminate heater encapsulated within an inert material;

FIG. 4 depicts a profile view of an example nanoparticle laminate heater encapsulated within a thermally conductive material and/or an electrically insulating material; and

FIG. 5 depicts a profile view of an example nanoparticle laminate heater encapsulated within an inert material, a thermally insulating material, and/or an electrically insulating material.

### DETAIL DESCRIPTION

Heated reinforcement bars and associated laminates are provided that may include carbon nanotubes. A heated reinforcement bar and/or associated laminate of the present disclosure may be a device used to convert electrical energy to heat. Heated reinforcement bars and associated laminates of the present disclosure may be incorporated into, or on, concrete structures (e.g., vertical structures, horizontal structures, concrete driveways, concrete sidewalks, etc.). The heated reinforcement bars and/or associated laminates of the present disclosure may be configured as either radiant or convection heating sources, or both. A heated reinforcement bar and/or associated laminate may vary in size from a few tens of feet to several hundred feet (a few metres to some hundred metres).

A nanoparticle composite may include a structure as disclosed, for example, in any one of U.S. Pat. Nos.: 9,377,449, entitled Nanocomposite oil sensors for downhole hydrocarbon detection; 9,372,151, entitled Cross antennas for surface-enhanced infrared absorption (SERA) spectroscopy of chemical moieties; 9,358,730, entitled Dynamic strain hardening in polymer nanocomposites; 9,356,151, entitled Fabrication of graphene nanoribbons and nanowires using a meniscus as an etch mask; 9,340,894, entitled Anode battery materials and methods of making the same; 9,321,021, entitled Converting nanoparticles in oil to aqueous suspensions; 9,312,540, entitled Conformal coating on nanostructured electrode materials for three-dimensional applications; 9,312,078, entitled Patterned graphite oxide films and methods to make and use same; 9,290,665, entitled Coated fullerenes, compositions and dielectrics made therefrom; 9,283,511, entitled Composite materials for reversible CO.sub.2 capture; 9,260,570, entitled Compression induced stiffening and alignment of liquid crystal elastomers; 9,255,853, entitled Non-contact strain sensing of objects by use of single-walled carbon nanotubes; 9,249,023, entitled Liquid crystals from single-walled carbon nanotube polyelectrolytes and their use for making various materials; 9,228,009, entitled Multi-hierarchical self-assembly of a collagen mimetic peptide; 9,222,665, entitled Waste remediation; 9,202,952, entitled Plasmon induced hot carrier device, method for using the same, and method for manufacturing the same; 9,129,720, entitled Synthesis of uniform nanoparticle shapes with high selectivity; 9,106,342, entitled Device and method for modulating transmission of terahertz waves; 9,096,437, entitled Growth of graphene films from non-gaseous carbon sources; 9,095,876, entitled Immobilized carbon nanotubes on various surfaces; 9,068,109, entitled Nano-encapsulated triggered-release viscosity breaker; 9,067,791, entitled Embedded arrays of vertically aligned carbon nanotube carpets and methods for making them; 9,061,268, entitled Synthesis of ultrasmall metal oxide nanoparticles; 9,034,085, entitled Aliphatic amine based nanocarbons for the absorption of carbon dioxide; 9,032,731, entitled Cooling systems and hybrid A/C systems using an electromagnetic radiation-absorbing complex; 9,005,460, entitled Layer-by-layer removal of grapheme; 8,992,881, entitled Graphene nanoribbons prepared from carbon nanotubes via alkali metal exposure; 8,986,942, entitled Carbon nanotube based imaging agents; 8,958,362, entitled Method and system for wirelessly transmitting data; 8,956,440, entitled High-yield synthesis of gold nanorods with optical absorption at wavelengths greater than 1000 nm using hydroquinone; 8,916,606, entitled Therapeutic compositions and methods for targeted delivery of active agents; 8,906,984, entitled Synthesis of metal and metal oxide nanoparticle-embedded siloxane composites; 8,816,042, entitled Polyamide composites having flexible spacers; 8,815,231, entitled Systems and methods for magnetic guidance and patterning of materials; 8,809,979, entitled Functionalized carbon nanotube-polymer composites and interactions with radiation; 8,784,866, entitled Water-soluble carbon nanotube compositions for drug delivery and medicinal applications; 8,732,468, entitled Protecting hardware circuit design by secret sharing; 8,709,373, entitled Strongly bound carbon nanotube arrays directly grown on substrates and methods for production thereof ; 8,703,090, entitled Methods for preparation of graphene nanoribbons from carbon nanotubes and compositions, thin films and devices derived therefrom; 8,679,442, entitled Fullerene compositions and methods for photochemical purification; 8,663,690, entitled Method for nanoencapsulation; 8,663,495, entitled Gelled nanotube-containing heat transfer medium; 8,636,830, entitled Aliphatic amine based nanocarbons for the absorption of carbon dioxide; 8,596,466, entitled Production of single-walled carbon nanotube grids; 8,591,854, entitled Methods for solubilizing and separating large fullerenes; 8,575,548, entitled Analyzing the transport of plasmonic particles through mineral formations; 8,562,935, entitled Amplification of carbon nanotubes via seeded-growth methods; 8,541,322, entitled Sidewall functionalization of carbon nanotubes with organosilanes for polymer composites; 8,540,959, entitled Bulk cutting of carbon nanotubes using electron beam irradiation; 8,460,428, entitled Single-crystalline metal nanorings and methods for synthesis thereof; 8,449,854, entitled Method for preparation of new superhard B-C-N material and material made therefrom; 8,440,467, entitled Electronic switching, memory, and sensor devices from a discontinuous graphene and/or graphite carbon layer on dielectric materials; 8,420,717, entitled Polyol functionalized water soluble carbon nanostructures; 8,398,950, entitled Condensation polymers having covalently bound carbon nanotubes; 8,395,901, entitled Vertically-stacked electronic devices having conductive carbon films; 8,394,664, entitled Electrical device fabrication from nanotube formations; 8,390,326, entitled Method for fabrication of a semiconductor element and structure thereof; 8,362,559, entitled Hybrid molecular electronic devices containing molecule-functionalized surfaces for switching, memory, and sensor applications and methods for fabricating same; 8,362,295, entitled Graphene compositions and methods for production thereof; 8,361,349, entitled Fabrication of light emitting film coated fullerenes and their application for in-vivo light emission; 8,337,809, entitled Charge-assembled capsules for phototherapy; 8,310,134, entitled Composition for energy generator, storage, and strain sensor and methods of use thereof; 8,269,501, entitled Methods for magnetic imaging of geological structures; 8,236,491, entitled Protein fragment complementation assay for thermophiles; 8,223,330, entitled Nanostructures and lithographic method for producing highly sensitive substrates for surface-enhanced spectroscopy; 8,217,137, entitled Fullerene-based amino acids; 8,201,517, entitled Method for low temperature growth of inorganic materials from solution using catalyzed growth and re-growth; 8,187,703, entitled Fiber-reinforced polymer composites containing functionalized carbon nanotubes; 8,183,180, entitled Graphene compositions and drilling fluids derived therefrom; 8,178,202, entitled Nonconcentric nano shells with offset core in relation to shell and method of using the same; 8,158,203, entitled Methods of attaching or grafting carbon nanotubes to silicon surfaces and composite structures derived therefrom; 8,128,901, entitled Facile purification of carbon nanotubes with liquid bromine at room temperature; 8,124,503, entitled Carbon nanotube diameter selection by pretreatment of metal catalysts on surfaces; 8,106,430, entitled Preparation of thin film transistors (TFTs) or radio frequency identification (RFID) tags or other printable electronics using ink-jet printer and carbon nanotube inks; 8,097,141, entitled Flow dielectrophoretic separation of single wall carbon nanotubes; 8,092,774, entitled Nanotube-amino acids and methods for preparing same; 8,089,628, entitled Pulsed-multiline excitation for color-blind fluorescence detection; 8,080,199, entitled Interaction of microwaves with carbon nanotubes to facilitate modification; 8,062,748, entitled Methods for preparing carbon nanotube/polymer composites using free radical precursors; 8,062,702, entitled Coated fullerenes, composites and dielectrics made therefrom; 8,058,613, entitled Micromechanical devices for materials characterization; 8,045,152, entitled All optical nanoscale sensor; 8,007,829, entitled Method to fabricate inhomogeneous particles; 8,003,215, entitled Fluorinated nanodiamond as a precursor for solid substrate surface coating using wet chemistry; 7,998,271, entitled Solvents and new method for the synthesis of CdSe semiconductor nanocrystals; 7,976,816, entitled Method for functionalizating carbon naontubes utilizing peroxides; 7,973,559, entitled Method for fabrication of a semiconductor element and structure thereof ; 7,959,779, entitled Macroscopically manipulable nanoscale devices made from nanotube assemblies; 7,940,043, entitled NMR method of detecting precipitants in a hydrocarbon stream; 7,939,136, entitled Method for forming composites of sub-arrays of fullerene nanotubes; 7,939,047, entitled Bulk separation of carbon nanotubes by bandgap; 7,938,991, entitled Polymer/carbon-nanotube interpenetrating networks and process for making same; 7,938,969, entitled Magnetic purification of a sample; 7,893,513, entitled Nanoparticle/nanotube-based nanoelectronic devices and chemically-directed assembly thereof; 7,887,774, entitled Methods for selective functionalization and separation of carbon nanotubes; 7,879,940, entitled Polymerization initated at sidewalls of carbon nanotubes; 7,858,186, entitled Fluorinated nanodiamond as a precursor for solid substrate surface coating using wet chemistry; 7,838,077, entitled Functionalized, hydrogen-passivated silicon surfaces; 7,829,119, entitled Method to fabricate microcapsules from polymers and charged nanoparticles; 7,825,064, entitled Supported catalysts using nanoparticles as the support material; 7,821,079, entitled Preparation of thin film transistors (TFTs) or radio frequency identification (RFID) tags or other printable electronics using ink-jet printer and carbon nanotube inks; 7,820,130, entitled Functionalization of nanodiamond powder through fluorination and subsequent derivatization reactions; 7,790,066, entitled Nanorice particles: hybrid plasmonic nano structures; 7,758,841, entitled Reductive functionalization of carbon nanotubes; 7,744,844, entitled Functionalized carbon nanotube-polymer composites and interactions with radiation; 7,740,826, entitled Method for functionalizing carbon nanotubes utilizing peroxides; 7,730,547, entitled Smart materials: strain sensing and stress determination by means of nanotube sensing systems, composites, and devices; 7,727,504, entitled Fibers comprised of epitaxially grown single-wall carbon nanotubes, and a method for added catalyst and continuous growth at the tip; 7,718,550, entitled Method for low temperature growth of inorganic materials from solution using catalyzed growth and re-growth; 7,692,218, entitled Method for creating a functional interface between a nanoparticle, nanotube or nanowire, and a biological molecule or system; 7,682,527, entitled Fabrication of light emitting film coated fullerenes and their application for in-vivo light emission; 7,682,523, entitled Fluorescent security ink using carbon nanotubes; 7,670,583, entitled Multi-step purification of single-wall carbon nanotubes; 7,655,302, entitled Continuous fiber of fullerene nanotubes; 7,632,569, entitled Array of fullerene nanotubes; 7,632,481, entitled Sidewall functionalization of nanotubes with hydroxyl terminated moieties; 7,601,421, entitled Fabrication of carbon nanotube reinforced epoxy polymer composites using functionalized carbon nanotubes; 7,585,420, entitled Carbon nanotube substrates and catalyzed hot stamp for polishing and patterning the substrates; 7,578,941, entitled Length-based liquid-liquid extraction of carbon nanotubes using a phase transfer catalyst; 7,572,426, entitled Selective functionalization of carbon nanotubes; 7,527,831, entitled Method of making a molecule-surface interface; 7,511,811, entitled Pulsed-multiline excitation for color-blind fluorescence detection; 7,510,695, entitled Method for forming a patterned array of fullerene nanotubes; 7,494,639, entitled Purification of carbon nanotubes based on the chemistry of fenton's reagent; 7,481,989, entitled Method for cutting fullerene nanotubes;7,470,417, entitled Ozonation of carbon nanotubes in fluorocarbons;7,452,519, entitled Sidewall functionalization of single-wall carbon nanotubes through C—N bond forming substitutions of fluoronanotubes;7,419,651, entitled Method for producing self-assembled objects comprising fullerene nanotubes and compositions thereof; 7,419,624, entitled Methods for producing composites of fullerene nanotubes and compositions thereof; 7,407,640, entitled Functionalized carbon nanotube-polymer composites and interactions with radiation; 7,390,767, entitled Method for producing a catalyst support and compositions thereof ; 7,390,477, entitled Fullerene nanotube compositions; 7,361,369, entitled Implant with structure allowing injection of polymer for attaching implant to tissue; 7,357,906, entitled Method for fractionating single-wall carbon nanotubes; 7,354,563, entitled Method for purification of as-produced fullerene nanotubes; 7,324,215, entitled Non-destructive optical imaging system for enhanced lateral resolution; 7,323,136, entitled Containerless mixing of metals and polymers with fullerenes and nanofibers to produce reinforced advanced materials; 7,306,828, entitled Fabrication of reinforced composite material comprising carbon nanotubes, fullerenes, and vapor-grown carbon fibers for thermal barrier materials, structural ceramics, and multifunctional nanocomposite ceramics; 7,264,876, entitled Polymer-wrapped single wall carbon nanotubes; 7,262,266, entitled Copolymerization of polybenzazoles and other aromatic polymers with carbon nanotubes; 7,253,014, entitled Fabrication of light emitting film coated fullerenes and their application for in-vivo light emission; 7,205,069, entitled Membrane comprising an array of single-wall carbon nanotubes; 7,204,970, entitled Single-wall carbon nanotubes from high pressure CO; 7,176,146, entitled Method of making a molecule-surface interface; 7,125,533, entitled Method for functionalizing carbon nanotubes utilizing peroxides; 7,115,864, entitled Method for purification of as-produced single-wall carbon nanotubes; 7,108,841, entitled Method for forming a patterned array of single-wall carbon nanotubes; 7,105,596, entitled Methods for producing composites of single-wall carbon nanotubes and compositions thereof; 7,097,820, entitled Continuous fiber of single-wall carbon nanotubes; 7,087,207, entitled Method for forming an array of single-wall carbon nanotubes in an electric field and compositions thereof; 7,071,406, entitled Array of single-wall carbon nanotubes; 7,067,098, entitled Method for forming an array of single-wall carbon nanotubes and compositions thereof; 7,052,666, entitled Method for cutting single-wall carbon nanotubes; 7,048,999, entitled Method for producing self-assembled objects comprising single-wall carbon nanotubes and compositions thereof; 7,048,903, entitled Macroscopically manipulable nanoscale devices made from nanotube assemblies; 7,041,620, entitled Method for producing a catalyst support and compositions thereof; 7,029,646, entitled Method for cutting single-wall carbon nanotubes through fluorination; 7,008,604, entitled Method for cutting nanotubes; 7,008,563, entitled Polymer-wrapped single wall carbon nanotubes; 6,995,841, entitled Pulsed-multiline excitation for color-blind fluorescence detection; 6,986,876, entitled Method for forming composites of sub-arrays of single-wall carbon nanotubes; 6,979,709, entitled Continuous fiber of single-wall carbon nanotubes; 6,949,237, entitled Method for growing single-wall carbon nanotubes utlizing seed molecules; 6,939,525, entitled Method of forming composite arrays of single-wall carbon nanotubes and compositions thereof; 6,936,306, entitled Chemical control over ceramic porosity using carboxylate-alumoxanes; 6,936,233, entitled Method for purification of as-produced single-wall carbon nanotubes; 6,875,475, entitled Methods for producing submicron metal line and island arrays; 6,824,755, entitled Method for producing a catalyst support and compositions thereof; 6,778,316, entitled Nanoparticle-based all-optical sensors; 6,761,870, entitled Gas-phase nucleation and growth of single-wall carbon nanotubes from high pressure CO; 6,756,026, entitled Method for growing continuous carbon fiber and compositions thereof; 6,756,025, entitled Method for growing single-wall carbon nanotubes utilizing seed molecules; 6,749,827, entitled Method for growing continuous fiber; 6,683,783, entitled Carbon fibers formed from single-wall carbon nanotubes; 6,428,762, entitled Powder synthesis and characterization of amorphous carbon nitride, a-C3N4; 6,369,183, entitled Methods and materials for fabrication of alumoxane polymers; 6,322,890, entitled Supra-molecular alkylalumoxanes; 6,124,373, entitled Bone replacement compound comprising poly(polypropylene fumarate); 6,018,390, entitled Integrated optics waveguide accelerometer with a proof mass adapted to exert force against the optical waveguide during acceleration; or U.S. Patent Application Publication Nos.: 20160163652, entitled COATED FULLERENES, COMPOSITES AND DIELECTRICS MADE THEREFROM; 20160153098, entitled SELF-IMPROVING ELECTROCATALYSTS FOR GAS EVOLUTION REACTIONS; 20160137875, entitled CONDUCTIVE POLYMER COATING COMPOSITION; 20160131637, entitled SUSPENDED NANO-ELECTRODES FOR ON-CHIP ELECTROPHYSIOLOGY; 20160068690, entitled CARBON NANOTUBE COATING COMPOSITION; 20160002673, entitled SOLAR STEAM PROCESSING OF BIOFUEL FEEDSTOCK AND SOLAR DISTILLATION OF BIOFUELS; 20150368539, entitled CARBONACEOUS NANOPARTICLES AS CONDUCTIVITY ENHANCEMENT ADDITIVES TO WATER-IN-OIL EMULSIONS, OIL-IN-WATER EMULSIONS AND OIL-BASED WELLB ORE FLUIDS; 20150360956, entitled PRODUCTION OF GRAPHENE NANOPLATELETS BY OXIDATIVE ANHYDROUS ACIDIC MEDIA; 20150307357, entitled PRODUCTION OF GRAPHENE NANORIBBONS BY OXIDATIVE ANHYDROUS ACIDIC MEDIA; 20150298164, entitled CARBON NANOTUBE FILMS PROCESSED FROM STRONG ACID SOLUTIONS AND METHODS FOR PRODUCTION THEREOF; 20150280248, entitled GRAPHENE QUANTUM DOT-CARBON MATERIAL COMPOSITES AND THEIR USE AS ELECTROCATALYSTS; 20150216975, entitled NANOVECTOR BASED DRUG DELIVERY SYSTEM FOR OVERCOMING DRUG RESISTANCE; 20150162381, entitled ADDRESSABLE SIOX MEMORY ARRAY WITH INCORPORATED DIODES; 20150108391, entitled SYNTHESIS OF MAGNETIC CARBON NANORIBBONS AND MAGNETIC FUNCTIONALIZED CARBON NANORIBBONS; 20150023858, entitled REBAR HYBRID MATERIALS AND METHODS OF MAKING THE SAME; 20140367091, entitled WELLBORE FLUIDS INCORPORATING MAGNETIC CARBON NANORIBBONS AND MAGNETIC FUNCTIONALIZED CARBON NANORIBBONS AND METHODS OF USING THE SAME; 20140363669, entitled CARBON NANOTUBES FIBER HAVING LOW RESISTIVITY, HIGH MODULUS AND/OR HIGH THERMAL CONDUCTIVITY AND A METHOD OF PREPARING SUCH FIBERS BY SPINNING USING A FIBER SPIN-DOPE; 20140357534, entitled METHODS, APPARATUS, AND SENSORS FOR TRACING FRAC FLUIDS IN MINERAL FORMATIONS, PRODUCTION WATERS, AND THE ENVIRONMENT USING MAGNETIC PARTICLES; 20140313636, entitled GRAPHENE-CARBON NANOTUBE HYBRID MATERIALS AND USE AS ELECTRODES; 20140255291, entitled LIQUID CRYSTALS FROM SINGLE-WALLED CARBON NANOTUBE POLYELECTROLYTES AND THEIR USE FOR MAKING VARIOUS MATERIALS; 20140193711, entitled COMBINED ELECTROCHEMICAL AND CHEMICAL ETCHING PROCESSES FOR GENERATION OF POROUS SILICON PARTICULATES; 20140187651, entitled MULTI-HIERARCHICAL SELF-ASSEMBLY OF A COLLAGEN MIMETIC PEPTIDE; 20140178688, entitled BERNAL-STACKED GRAPHENE LAYERS AND METHODS OF MAKING THE SAME; 20140154269, entitled TARGETED NANOVECTORS AND THEIR USE FOR TREATMENT OF BRAIN TUMORS; 20140141224, entitled FABRICATION OF CARBON FOAMS THROUGH SOLUTION PROCESSING IN SUPERACIDS; 20140120453, entitled PATTERNED GRAPHITE OXIDE FILMS AND METHODS TO MAKE AND USE SAME; 20140120167, entitled MULTIFUNCTIONAL CHEMO- AND MECHANICAL THERAPEUTICS; 20140120081, entitled USE OF CARBON NANOMATERIALS WITH ANTIOXIDANT PROPERTIES TO TREAT OXIDATIVE STRESS; 20140103255, entitled ALIPHATIC AMINE BASED NANOCARBONS FOR THE ABSORPTION OF CARBON DIOXIDE; 20140097842, entitled ELECTRON SPIN RESONANCE FOR MEDICAL IMAGING; 20140094391, entitled BIO-NANO-CHIPS FOR ON-SITE DRUG SCREENING; 20140084219, entitled DOPED MULTIWALLED CARBON NANOTUBE FIBERS AND METHODS OF MAKING THE SAME; 20140081067, entitled SORPTION AND SEPARATION OF VARIOUS MATERIALS BY GRAPHENE OXIDES; 20140077138, entitled BORON NITRIDE-BASED FLUID COMPOSITIONS AND METHODS OF MAKING THE SAME; 20140048748, entitled GRAPHENE NANORIBBON COMPOSITES AND METHODS OF MAKING THE SAME; 20140014030, entitled METHODS FOR PRODUCTION OF SINGLE-CRYSTAL GRAPHENES; 20140011034, entitled GRAPHITE OXIDE COATED PARTICULATE MATERIAL AND USES THEREOF; 20130345099, entitled Nano-Encapsulated Triggered-Release Viscosity Breaker; 20130334104, entitled DISTILLING A CHEMICAL MIXTURE USING AN ELECTROMAGNETIC RADIATION-ABSORBING COMPLEX FOR HEATING; 20130319973, entitled LAYER-BY-LAYER REMOVAL OF GRAPHENE; 20130306463, entitled PURIFYING A FLUID USING A HEAT CARRIER COMPRISING AN ELECTROMAGNETIC RADIATION-ABSORBING COMPLEX; 20130299933, entitled PLASMON INDUCED HOT CARRIER DEVICE, METHOD FOR USING THE SAME, AND METHOD FOR MANUFACTURING THE SAME; 20130295580, entitled ORAL CANCER POINT OF CARE DIAGNOSTICS; 20130274136, entitled PROSTATE CANCER POINT OF CARE DIAGNOSTICS; 20130264121, entitled GRAPHENE-BASED MATERIAL FOR SHALE STABILIZATION AND METHOD OF USE; 20130190472, entitled POLYAMIDE COMPOSITES HAVING FLEXIBLE SPACERS; 20130168543, entitled ANALYZING THE TRANSPORT OF PLASMONIC PARTICLES THROUGH MINERAL FORMATIONS; 20130130933, entitled BIOMARKER SIGNATURES FOR WELLNESS TESTING; 20130108826, entitled PRODUCTION OF HIGHLY CONDUCTIVE CARBON NANOTUBE-POLYMER COMPOSITES; 20130095314, entitled IMMOBILIZED CARBON NANOTUBES ON VARIOUS SURFACES; 20130090511, entitled SYNTHESIS OF ULTRASMALL METAL OXIDE NANOPARTICLES; 20130069271, entitled DYNAMIC STRAIN HARDENING IN POLYMER NANOCOMPOSITES; 20130048339, entitled TRANSPARENT ELECTRODES BASED ON GRAPHENE AND GRID HYBRID STRUCTURES; 20130045420, entitled ANODE BATTERY MATERIALS AND METHODS OF MAKING THE SAME; 20130017453, entitled Conformal Coating On Nanostructured Electrode Materials For Three-Dimensional Applications; 20120302816, entitled THERAPEUTIC COMPOSITIONS AND METHODS FOR TARGETED DELIVERY OF ACTIVE AGENTS; 20120267893, entitled ELECTRICITY GENERATION USING ELECTROMAGNETIC RADIATION; 20120238021, entitled METHODS OF SYNTHESIZING THREE-DIMENSIONAL HETEROATOM-DOPED CARBON NANOTUBE MACRO MATERIALS AND COMPOSITIONS THEREOF; 20120231326, entitled STRUCTURED SILICON BATTERY ANODES; 20120213994, entitled X-RAY ABSORBING COMPOSITIONS AND METHODS OF MAKING THE SAME; 20120208008, entitled GRAPHENE-BASED THIN FILMS IN HEAT CIRCUITS AND METHODS OF MAKING THE SAME; 20120189492, entitled FULLERENE COMPOSITIONS AND METHODS FOR PHOTOCHEMICAL PURIFICATION; 20120156102, entitled WASTE REMEDIATION; 20120155841, entitled GENERATING A HEATED FLUID USING AN ELECTROMAGNETIC RADIATION-ABSORBING COMPLEX; 20120153621, entitled COOLING SYSTEMS AND HYBRID A/C SYSTEMS USING AN ELECTROMAGNETIC RADIATION-ABSORBING COMPLEX; 20120119162, entitled Coated Fullerenes, Compositions And Dielectrics Made Therefrom; 20120090816, entitled SYSTEMS AND METHODS FOR HEAT TRANSFER UTILIZING HEAT EXCHANGERS WITH CARBON NANOTUBES; 20120024153, entitled ALIPHATIC AMINE BASED NANOCARBONS FOR THE ABSORPTION OF CARBON DIOXIDE; 20110318248, entitled Methods for Solubilizing and Separating Large Fullerenes; 20110311427, entitled Strongly Bound Carbon Nanotube Arrays Directly Grown On Substrates And Methods For Production Thereof; 20110287462, entitled PROTEIN FRAGMENT COMPLEMENTATION ASSAY FOR THERMOPHILES; 20110274624, entitled CONTRAST AGENTS IN POROUS PARTICLES; 20110220839, entitled CONVERTING NANOPARTICLES IN OIL TO AQUEOUS SUSPENSIONS; 20110213288, entitled Device And Method For Transfecting Cells For Therapeutic Uses; 20110201764, entitled POLYMER/CARBON-NANOTUBE INTERPENETRATING NETWORKS AND PROCESS FOR MAKING SAME; 20110086781, entitled METHOD FOR FORMING COMPOSITES OF SUB-ARRAYS OF FULLERENE NANOTUBES; 20110079770, entitled Preparation of Thin Film Transistors (TFTs) or Radio Frequency Identification (RFID) Tags or Other Printable Electronics Using Ink-Jet Printer and Carbon Nanotube Inks; 20110065946, entitled FLUORINATED NANODIAMOND AS A PRECURSOR FOR SOLID SUBSTRATE SURFACE COATING USING WET CHEMISTRY; 20110032511, entitled SYSTEM AND METHOD TO MEASURE NANO-SCALE STRESS AND STRAIN IN MATERIALS; 20100317820, entitled Polyol Functionalized Water Soluble Carbon Nanostructures; 20100303913, entitled Method for Nanoencapsulation; 20100294976, entitled COMPOSITION FOR ENERGY GENERATOR, STORAGE, AND STRAIN SENSOR AND METHODS OF USE THEREOF; 20100289524, entitled Method for Fabrication of a Semiconductor Element and Structure Thereof; 20100287374, entitled Protecting Hardware Circuit Design by Secret Sharing; 20100284898, entitled BULK CUTTING OF CARBON NANOTUBES USING ELECTRON BEAM IRRADIATION; 20100284156, entitled VERTICALLY-STACKED ELECTRONIC DEVICES HAVING CONDUCTIVE CARBON FILMS; 20100283504, entitled METHOD FOR FABRICATION OF A SEMICONDUCTOR ELEMENT AND STRUCTURE THEREOF; 20100279128, entitled Single-Crystalline Metal Nanorings and Methods for Synthesis Thereof; 20100252824, entitled Hybrid Molecular Electronic Devices Containing Molecule-Functionalized Surfaces for Switching, Memory, and Sensor Applications and Methods for Fabricating Same; 20100222536, entitled Method for Functionalizating Carbon Naontubes Utilizing Peroxides; 20100222501, entitled SCALABLE PROCESS FOR SYNTHESIZING UNIFORMLY-SIZED COMPOSITE NANOPARTICLES; 20100209632, entitled Fluorescent Carbon Nanotube Compositions Deposited on Surfaces; 20100186665, entitled Method for low temperature growth of inorganic materials from solution using catalyzed growth and re-growth; 20100151248, entitled Fabrication of light emitting film coated fullerenes and their application for in-vivo emission; 20100143230, entitled METHOD FOR PREPARATION OF NEW SUPERHARD B—C—N MATERIAL AND MATERIAL MADE THEREFROM; 20100139946, entitled SELF-ASSEMBLED NANOPARTICLES-NANOTUBE STRUCTURES BASED ON ANTENNA CHEMISTRY OF CONDUCTIVE NANORODS; 20100133513, entitled NANOPARTICLE/NANOTUBE-BASED NANOELECTRONIC DEVICES AND CHEMICALLY-DIRECTED ASSEMBLY THEREOF; 20100120942, entitled SYNTHESIS OF METAL AND METAL OXIDE NANOPARTICLE-EMBEDDED SILOXANE COMPOSITES; 20100113696, entitled METHODS FOR PREPARING CARBON NANOTUBE/POLYMER COMPOSITES USING FREE RADICAL PRECURSORS; 20100108884, entitled Micromechanical Devices for Materials Characterization; 20100096265, entitled MACROSCOPICALLY MANIPULABLE NANOSCALE DEVICES MADE FROM NANOTUBE ASSEMBLIES; 20100040549, entitled Composition for Targeted Drug Delivery and Controlled Release; 20100035047, entitled METAL AND METAL OXIDE NANOPARTICLE-EMBEDDED COMPOSITES; 20100028680, entitled Nonconcentric nanoshells and methods of making and using same; 20100028247, entitled METHODS FOR SELECTIVE FUNCTIONALIZATION AND SEPARATION OF CARBON NANOTUBES; 20100021367, entitled FACILE PURIFICATION OF CARBON NANOTUBES WITH LIQUID BROMINE AT ROOM TEMPERATURE; 20100008843, entitled MULTI-STEP PURIFICATION OF SINGLE-WALL CARBON NANOTUBES; 20090294753, entitled CARBON NANOTUBE DIAMETER SELECTION BY PRETREATMENT OF METAL CATALYSTS ON SURFACES; 20090269593, entitled FUNCTIONALIZED, HYDROGEN-PASSIVATED SILICON SURFACES; 20090197315, entitled FULLERENE-BASED AMINO ACIDS; 20090173935, entitled PREPARATION OF THIN FILM TRANSISTORS (TFT's) OR RADIO FREQUENCY IDENTIFICATION (RFID) TAGS OR OTHER PRINTABLE ELECTRONICS USING INK-JET PRINTER AND CARBON NANOTUBE INKS; 20090169463, entitled ARRAY OF FULLERENE NANOTUBES; 20090124747, entitled CONDENSATION POLYMERS HAVING COVALENTLY BOUND CARBON NANOTUBES; 20090099276, entitled FUNCTIONALIZED CARBON NANOTUBE-POLYMER COMPOSITES AND INTERACTIONS WITH RADIATION; 20090027069, entitled FUNCTIONALIZED CARBON NANOTUBE-POLYMER COMPOSITES AND INTERACTIONS WITH RADIATION; 20090004094, entitled METHOD FOR CUTTING FULLERENE NANOTUBES; 20080311025, entitled METHOD FOR FORMING A PATTERNED ARRAY OF FULLERENE NANOTUBES; 20080260616, entitled Bulk Separation of Carbon Nanotubes by Bandgap; 20080224100, entitled METHODS FOR PRODUCING COMPOSITES OF FULLERENE NANOTUBES AND COMPOSITIONS THEREOF; 20080213162, entitled Amplification of Carbon Nanotubes Via Seeded-Growth Methods; 20080176212, entitled All optical nanoscale sensor; 20080171204, entitled Fabrication of light emitting film coated fullerenes and their application for in-vivo light emission; 20080169061, entitled INTERACTION OF MICROWAVES WITH CARBON NANOTUBES TO FACILITATE MODIFICATION; 20080107586, entitled METHOD FOR PRODUCING A CATALYST SUPPORT AND COMPOSITIONS THEREOF; 20080105648, entitled Carbon nanotube substrates and catalyzed hot stamp for polishing and patterning the substrates; 20080089830, entitled FULLERENE NANOTUBE COMPOSITIONS; 20080063588, entitled METHOD FOR PURIFICATION OF AS-PRODUCED FULLERENE NANOTUBES; 20080063585, entitled FULLERENE NANOTUBE COMPOSITIONS; 20080048364, entitled Polymer/Carbon-Nanotube Interpenetrating Networks and Process for Making Same; 20080014654, entitled Efficient fluorimetric analyzer for single-walled carbon nanotubes; 20070298669, entitled Sidewall Functionalization Of Carbon Nanotubes With Organosilanes For Polymer Composites; 20070297216, entitled SELF-ASSEMBLY OF MOLECULAR DEVICES; 20070280876, entitled Functionalization of Carbon Nanotubes in Acidic Media; 20070259994, entitled Elastomers Reinforced with Carbon Nanotubes; 20070249180, entitled METHOD OF MAKING A MOLECULE-SURFACE INTERFACE; 20070228317, entitled FABRICATION OF REINFORCED COMPOSITE MATERIAL COMPRISING CARBON NANOTUBES, FULLERENES, AND VAPOR-GROWN CARBON FIBERS FOR THERMAL BARRIER MATERIALS, STRUCTURAL CERAMICS, AND MULTIFUNCTIONAL NANOCOMPOSITE CERAMICS; 20070204790, entitled Solvents and new method for the synthesis of cdse semiconductor nanocrystals; 20070118937, entitled Copolymerization and copolymers of aromatic polymers with carbon nanotubes and products made therefrom; 20070110658, entitled Water-soluble single-wall carbon nanotubes as a platform technology for biomedical applications; 20070099792, entitled Carbon nanotube reinforced thermoplastic polymer composites achieved through benzoyl peroxide initiated interfacial bonding to polymer matrices; 20070098620, entitled Method for functionalizing carbon nanotubes utilizing peroxides; 20070071667, entitled Thermal treatment of functionalized carbon nanotubes in solution to effect their functionalization; 20070062411, entitled Fluorescent security ink using carbon nanotubes; 20070048209, entitled Continuous fiber of fullerene nanotubes; 20070043158, entitled Method for producing self-assembled objects comprising fullerene nanotubes and compositions thereof; 20070009421, entitled Fibers comprised of epitaxially grown single-wall carbon nanotubes, and a method for added catalyst and continuous growth at the tip; 20070009417, entitled Supported catalysts using nanoparticles as the support material; 20060269467, entitled Fluorinated nanodiamond as a precursor for solid substrate surface coating using wet chemistry; 20060253942, entitled Smart materials: strain sensing and stress determination by means of nanotube sensing systems, composites, and devices; 20060202168, entitled Functionalized carbon nanotube-polymer composites and interactions with radiation; 20060201880, entitled Length-based liquid-liquid extraction of carbon nanotubes using a phase transfer catalyst; 20060171874, entitled Sidewall functionalization of single-wall carbon nanotubes through C—N bond forming substitutions of fluoronanotubes; 20060166003, entitled Fabrication of carbon nanotube reinforced epoxy polymer composites using functionalized carbon nanotubes; 20060159921, entitled Method to fabricate inhomogeneous particles; 20060159612, entitled Ozonation of carbon nanotubes in fluorocarbons; 20060148272, entitled Fabrication of light emitting film coated fullerenes and their application for in-vivo light emission; 20060139634 Pulsed-multiline excitation for color-blind fluorescence detection; 20060135001, entitled Method for low temperature growth of inorganic materials from solution using catalyzed growth and re-growth; 20060051290, entitled Short carbon nanotubes as adsorption and retention agents; 20050260120, entitled Method for forming an array of single-wall carbon nanotubes in an electric field and compositions thereof; 20050249656, entitled METHOD FOR FORMING A PATTERNED ARRAY OF SINGLE-WALL CARBON NANOTUBES; 20050244326, entitled Method for fractionating single-wall carbon nanotubes; 20050171281, entitled Copolymerization of polybenzazoles and other aromatic polymers with carbon nanotubes; 20050158390, entitled Method to fabricate microcapsules from polymers and charged nanoparticles; 20050129726, entitled Pre-fabricated tissue-engineered plug; 20050089684, entitled Coated fullerenes, composites and dielectrics made therefrom; 20050018274, entitled Nanoparticle-based all-optical sensors; 20040265209, entitled Method for end-derivatizing single-wall carbon nanotubes and for introducing an endohedral group to single-wall carbon nanotubes; 20040223900, entitled Method for functionalizing carbon nanotubes utilizing peroxides; 20040222081, entitled Use of microwaves to crosslink carbon nanotubes; 20040222080, entitled Use of microwaves to crosslink carbon nanotubes to facilitate modification; 20040023479, entitled Method of making a molecule-surface interface; 20040009298, entitled Methods for producing submicron metal line and island arrays; 20030215638, entitled Reduced symmetry nanoparticles; 20030174384, entitled Nanoparticle-based all-optical sensors; 20030106998, entitled Method for producing boron nitride coatings and fibers and compositions thereof; 20030066960, entitled Apparatus for growing continuous single-wall carbon nanotube fiber; 20030010910, entitled Continuous fiber of single-wall carbon nanotubes; 20020159943, entitled Method for forming an array of single-wall carbon nanotubes and compositions thereof; 20020150524, entitled Methods for producing composites of single-wall carbon nanotubes and compositions thereof; 20020136683, entitled Method for forming composites of sub-arrays of single-wall carbon nanotubes; 20020136681, entitled Method for producing a catalyst support and compositions thereof; 20020127169, entitled Method for purification of as-produced single-wall carbon nanotubes; 20020127162, entitled Continuous fiber of single-wall carbon nanotubes; 20020109087, entitled Method for producing a catalyst support and compositions thereof; 20020109086, entitled Method for growing continuous carbon fiber and compositions thereof;20020102201, entitled Method for forming an array of single-wall carbon nanotubes in an electric field and compositions thereof; 20020102196, entitled Compositions and articles of manufacture; 20020098135, entitled Array of single-wall carbon nanotubes; 20020096634, entitled Method for cutting single-wall carbon nanotubes; 20020094311, entitled Method for cutting nanotubes; 20020092984, entitled Method for purification of as-produced single-wall carbon nanotubes; 20020092983, entitled Method for growing single-wall carbon nanotubes utilizing seed molecules; 20020090331, entitled Method for growing continuous fiber; 20020090330, entitled Method for growing single-wall carbon nanotubes utlizing seed molecules; 20020088938, entitled Method for forming an array of single-wall carbon nanotubes and compositions thereof ; 20020085968, entitled Method for producing self-assembled objects comprising single-wall carbon nanotubes and compositions thereof; and 20020084410, entitled Macroscopically manipulable nanoscale devices made from nanotube assemblies, the disclosures of which are incorporated herein in their entireties by reference thereto.

For example, electro-thermal nanotubes may be held in suspension within a urethane base. The electro-thermal nanotubes may be microscopic fibers of carbon that may conduct electricity, convert electricity into thermal energy, and are very durable. When energized, the nanotubes may act as resistive heating elements that heat up as electrical energy flows through, and may increase in temperature as the electrical energy increases, thereby, the nanotube coating may function as a radiant heat source. The electro-thermal nanotubes may work with either alternating current (AC) or direct current (DC) electrical sources and temperature control may be achieved using off the shelf technology. A nanotube/urethane composite may be used as a spray on thermal coating that may convert a surface, on to which the composite is sprayed, into a radiant heat source.

While laminate heating elements including carbon nanotubes are described herein in conjunction with heated reinforcement bar applications, the laminate heating elements may be incorporated into numerous applications (e.g., heating asphalt, heating concrete, heating airplane wings and fuselages, water heaters, air heating, heating batteries, heated food containers, heated drink containers, heated garments, etc.). In fact, the laminate heating elements of the present disclosure may generally be incorporated in any convection, conduction and/or radiant heating application.

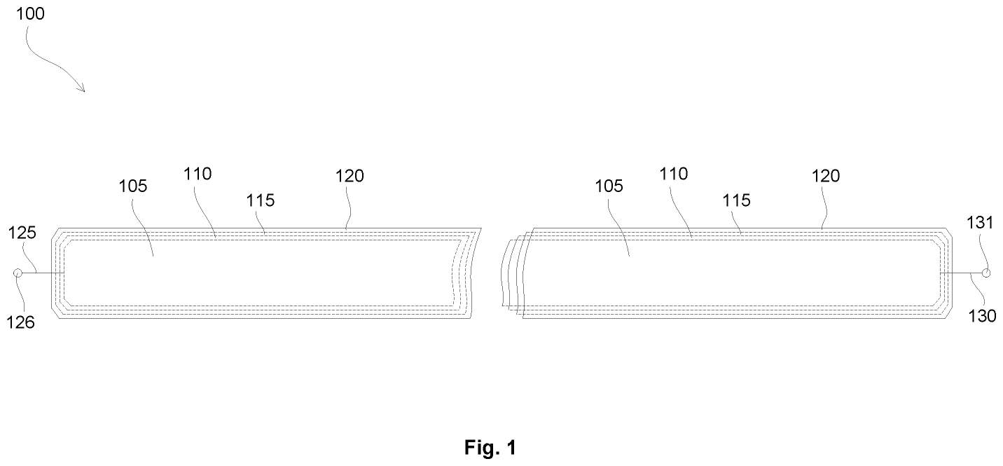

Turning to FIG. 1, a heated reinforcement bar 100 may include a reinforcement bar 105 and a laminate heating element. The reinforcement bar 105 may be a steel bar, an iron bar, a fiberglass bar, a composite bar (e.g., a carbon reinforced composite, etc.), etc. The laminate heating element may include an electrically insulating material 110, a nanoparticle heating layer 115, and an encapsulating layer 120. When, for example, the reinforcement bar 105 is non-electrically conductive, the electrically insulating material 110 may not be desired. The encapsulating layer 120 may be, for example, a thermally conductive and electrically insulating material.

Additionally, or alternatively, the encapsulating layer 120 may be a chemically inert material. For example, the encapsulating layer 120 may be a material that does not react with materials within concrete. The encapsulating layer 120 may define (or include) an armor plating to protect the electrically insulating material 110, the nanoparticle heating layer 115 and/or the encapsulating layer 120.

The heated reinforcement bar 100 may include an anode 115 with positive connection 126 and a cathode 230 with negative connection 131. While not shown in FIG. 1, an alternating current source or a direct current source may be connected to the positive connection 126 and the negative connection 131 to supply electrical energy to the nanoparticle heating layer 115.

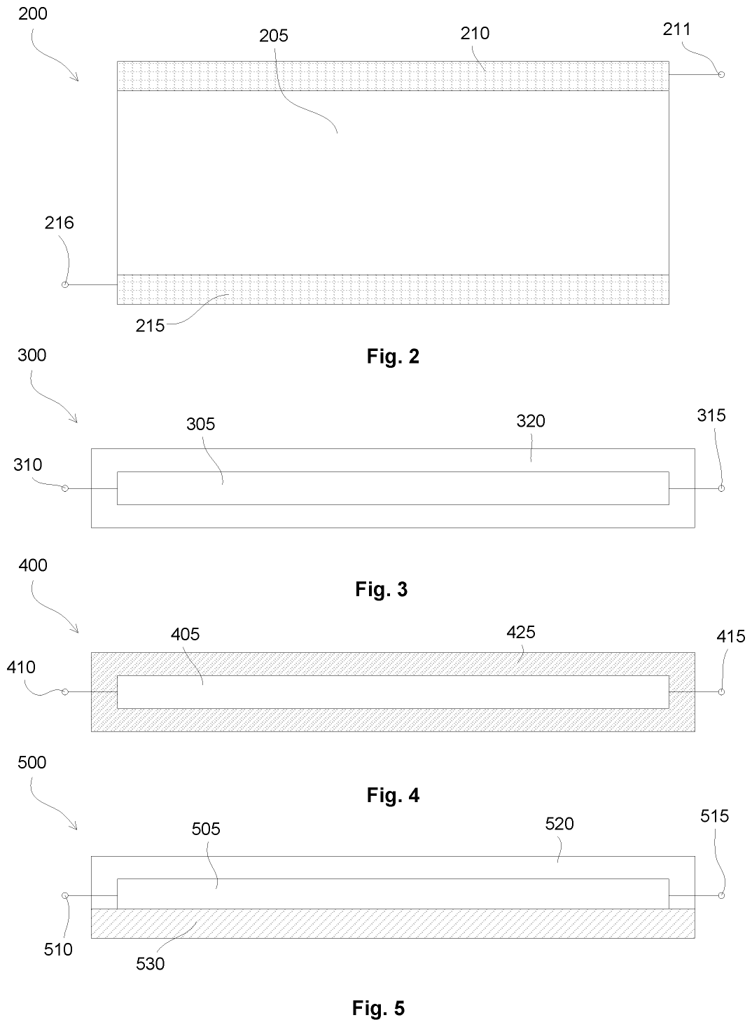

With referenced to FIG. 2, a nanoparticle laminate heating element 200 may include a nanoparticle laminate 205 including a first electrode 210 having an activation connection 211, and a second electrode 215 having a negative connection 212. The nanoparticle laminate 205 may include a nanometer-scale tube-like structure (e.g., BCN nanotube, ˜BCN nanotube, ˜BC2N nanotube, boron nitride nanotube, carbon nanotube, DNA nanotube, gallium nitride nanotube, silicon nanotube, inorganic nanotube, tungsten disulphide nanotube, membrane nanotube having a tubular membrane connection between cells, titania nanotubes, tungsten sulfide nanotubes, etc.). The nanoparticle heating element 200 may be similar to, for example, the nanoparticle laminate heating elements of FIG. 1.

Turning to FIG. 3, a heating element 300 may include a nanoparticle laminate heater 305 encapsulated within an inert material 320 (e.g., glass, silicon, porcelain, etc). The nanoparticle heater 305 may be similar to, for example, the nanoparticle laminate heating elements of FIG. 1, or the nanoparticle laminate heating element 200 of FIG. 2. The heating element 300 may also include an activation terminal 310 and a negative terminal 315.

With reference to FIG. 4, an element 400 may include a nanoparticle laminate heater 405 encapsulated within a thermally conductive material 425 (e.g., metal, tin, copper, glass, silicon, porcelain, etc). The nanoparticle heater 405 may be similar to, for example, the nanoparticle laminate heating elements of FIG. 1, or the nanoparticle laminate heating element 200 of FIG. 2, or the nanoparticle heater 300 of FIG. 3. The heating element 400 may also include an activation terminal 410 and a negative terminal 415.

Turning to FIG. 5, an element 500 may include a nanoparticle laminate heater 505 encapsulated within an inert material 520 and a thermally insulating material 530. The nanoparticle heater 505 may be similar to, for example, the nanoparticle laminate heating elements of FIG. 1, the nanoparticle laminate heating element 200 of FIG. 2, the nanoparticle heater 300 of FIG. 3, or the nanoparticle heater 405 of FIG. 4. The heating element 500 may also include an activation terminal 510 and a negative terminal 515.

The thermally insulating material 530 may be fiberglass, mineral wool, cellulose, polyurethane foam, polystyrene, aerogel (used by NASA for the construction of heat resistant tiles, capable of withstanding heat up to approximately 2000 degrees Fahrenheit with little or no heat transfer), natural fibers (e.g., hemp, sheep's wool, cotton, straw, etc.), polyisocyanurate, or polyurethane.

An element 26, 30, 32, 200, 300, 400, 500 may include an adhesive layer (e.g., a pressure sensitive adhesive layer, a peal-and-stick pressure sensitive adhesive layer, a UV curable adhesive layer, a temperature curable adhesive layer, a magnetic adhesive layer, etc.). Thereby, the element 26, 30, 32, 200, 300, 400, 500 may, for example, adhere to a surface to be heated.

A element 26, 30, 32, 200, 300, 400, 500 may include sidewall-functionalized carbon nanotubes. The functionalized carbon nanotubes may include hydroxyl-terminated moieties covalently attached to their sidewalls. Methods of forming the functionalized carbon nanotubes may involve chemistry on carbon nanotubes that have first been fluorinated. In some embodiments, fluorinated carbon nanotubes (“fluoronanotubes”) may be reacted with mono-metal salts of a dialcohol, MO—R—OH. M may be a metal and R may be a hydrocarbon or other organic chain and/or ring structural unit. In such embodiments, —O—R—OH may displace —F on the associated nanotube, the fluorine may leave as MF. Generally, such mono-metal salts may be formed in situ by addition of MOH to one or more dialcohols in which the fluoronanotubes have been dispersed. Fluoronanotubes may be reacted with amino alcohols, such as being of the type H2N—R—OH, wherein —N(H)—R—OH displaces —F on the nanotube, the fluorine may leave as HF.

A heating element 26, 30, 32, 200, 300, 400, 500 may include carbon nanotubes integrated into an epoxy polymer composite via, for example, chemical functionalization of the carbon nanotubes. Integration of the carbon nanotubes into an epoxy polymer may be enhanced through dispersion and/or covalent bonding with an epoxy matrix during a curing process. In general, attachment of chemical moieties (i.e., functional groups) to a sidewall and/or end-cap of carbon nanotubes such that the chemical moieties may react with either epoxy precursor, a curing agent, or both during the curing process. Additionally, chemical moieties can function to facilitate dispersion of carbon nanotubes with an epoxy matrix by decreasing van der Waals attractive forces between the nanotubes.

A heating element 200, 300, 400, 500 may include a carbon nanotube carpet that may include a resistance of a nanotube, and/or the nanotube carpet, of between about 0.1 kΩ and about 10.0 kΩ. Instead, the resistance of a nanotube may be between about 2.0 kΩ and about 8.0 kΩ. As an another alternative, the resistance of a nanotube may be between about 3.0 kΩ and about 7.0 kΩ. A conductive layer/contact may include single or dual damascene copper interconnects, poly-silicon interconnects, silicides, nitrides, and refractory metal interconnects such as, but not limited to, Al, Ti, Ta, Ru, W, Nb, Zr, Hf, Ir, La, Ni, Co, Au, Pt, Rh, Mo, and their combinations. An insulating material or materials may be coated onto individual tubes and/or bundles of tubes (nanotubes) to isolate the tubes and/or bundles from a conductive material. An insulating material may completely cover the tubes and/or bundles. Alternatively, gaps or other discontinuities may be included in the insulating material such that the nanotubes and/or bundles of nanotubes are not completely covered. The insulating material may include polymeric, oxide materials, and/or the like.

The laminate materials may be used with various materials for various applications, each incorporating a coating of material containing carbon-nanotube particles on a substrate. When an appropriate electrical current is applied to the surface of the coated substrate, heat is generated and such property enhances the utility of the substrate upon which the coating has been applied. Typical coatings and methods of making such coatings are described in U.S. Pat. No. 7,938,991 entitled Polymer/Carbon-Nanotube Interpenetrating Networks and Process for Making Same. Other methods can be utilized as long as the carbon-nanotube material can be sprayed, painted, dipped or otherwise applied, coated or deposited on a substrate material. Once the carbon-nanotube coating is applied to the substrate, the coating can be protected with a chemical coating or a layer of material providing waterproofing, abrasion resistance or other mechanical properties not found in the coating. A nanoparticle heating layer 115 (e.g., a carbon-nanotube coating) may be applied to a substrate with a peel-and-stick backing layer. The nano-particle heating layer may be applied to the surface of the substrate opposite the peel-and-stick layer. Thereafter, the composite can, for example, be installed on top of concrete, blacktop or other material used for walking surfaces, driveways, parking lots or other surfaces, using the peel-and-stick layer to bond the composite to the surface. A laminate heater may be installed over an existing walkway. Similarly, a laminate can be installed on existing driveways. Typically, a protective coating is placed over the composite material to protect it against abrasion and to provide a finished look to the surface. The laminate material may be applied to existing walkways by removing the peel-and-stick layer and pressing the composite material firmly onto the surface so that it adheres to the existing walkway. Parallel rows of material can be utilized. The spacing will depend upon such factors as the amount of heat required, the amount of power available and other factors. Once the laminate material is applied, contacts made of copper or other material are then applied to the surface of the carbon-nanotube coating. Typically, the contact material is applied in parallel lines. The spacing between contacts and the voltage applied across the contacts will determine the amount of heat the composite material will generate in the area between contacts. Additionally, it is possible to connect adjacent or alternating lines of contact by utilizing insulative material to provide a physical jumper over adjacent strips to avoid short circuits. Electrical terminals may be crimped to the end of the contact lines. After the parallel lines of laminate material are placed on the existing surface and the contacts connected, a protective coating, for example, of cement, is placed over the existing walkway over the carbon-nanotube laminated material. Adjacent strips of material can be connected in parallel or series. After the laminate material is fastened to the bottom surface using the peel-and-stick material or other suitable adhesive, the conductors connected and the terminals crimped on the end of the conductors, a current of suitable voltage is applied across the contacts. When the electrical current is applied, the carbon-nanotube coating will heat up. The heat is somewhat proportional to the amount of current applied. The coated laminate material can be used on top of existing roof tiles, under newly installed roof tiles to avoid ice damming, and can be utilized on other surfaces to avoid the formation of ice as well. Other uses of the nanoparticle coating include radiant heating for floors, walls, and ceilings, roofing underlayment, for wallpaper and for other indoor or outdoor applications benefitting from the application of heat to vertical or horizontal surfaces. When the carbon-nanotube coating is applied to a peel-and-stick material or a fabric substrate, the substrate can be cut to any length without having to worry about cutting heating wires. Further, substantially the entire surface of the carbon-nanotube coated material becomes heated, in contrast to a system using heated wires. The carbon-nanotube coating can be applied to essentially any substrate having the appropriate weight or strength requirements as long as the material is somewhat heat resistant. In some applications, the carbon-nanotube coating can be heated as high as 600° F. In such case, the substrate material must be able to withstand such heat without mechanical degradation. A suitable material for use as a substrate may include cross-woven poly material. An illustrative embodiment of the invention is made of a cross-woven poly product. A lamination layer may be next applied to the poly product and the nonwoven material is bonded to the cross-woven poly material. The nanoparticle solution may be applied to the surface. Electrical leads are either applied before or after the carbon-nanotube solution is sprayed on the laminated material and, if desired, another layer of laminate can be applied to protect the carbon-nanotube layer and the leads. The nanoparticle coating can be applied to a thermally insulative and waterproof barrier of the type sold by Insulation Solutions under the trademark Insul-Tarp for use under a poured foundation. When the coated Insul-Tarp material is used in the method taught by U.S. Pat. No. 7,000,359, the nano-coated blanket system can be used to generate heat in addition to its properties as an insulator and moisture barrier. Also, such heat may make the blanket material function as a more effective moisture barrier. The nanoparticle coated laminate material described above can be utilized in a radiant floor application between the sub-floor and finished floor. Alternatively, the nanoparticle laminate material can be used under floor joists in wall and ceiling applications to radiate heat when current is applied. When used in a roofing application, the nanoparticle laminate can be applied to a roofing underlayment material and thereafter, when activated, can melt snow and ice to eliminate damming at the eaves and gutters. Another embodiment of the present invention is to utilize a geogrid coated with the carbon-nanotube material. The coated grid can then be placed underground, allowing water to pass through it but providing heat to melt any surface ice, for example, when used in a sports field. The nanoparticle coating can be applied to essentially any insulating material. If the insulating material is flexible, such as fiberglass, the combination of the heat-generating carbon-nanotube coating material and insulation is much more effective than simply insulation by itself. The nanoparticle coated material can be applied to foam board, cement board or other rigid structure and the material will then become a heat-producing panel. When used with appropriate coating materials and the application of sufficient current, the nanoparticle coated material can be material in a space heater as the heat source, in a water heater, for heating for fuel tanks and the like. The carbon-nanotube coating can also be applied to clothing. The amount of heat generated by the nanoparticle coated material may be dependent upon the amount or thickness of the coating applied to the carrier material, the voltage applied across the contacts and the distance between contacts. Also, the closer the power leads are installed to each other, the greater the heat will be generated at a given voltage. The nanoparticle coating can be applied to foam material used between the ground and poured concrete foundations to provide some degree of radiant heating for the floor. Alternatively, heat-producing material can be produced by coating materials with the carbon-nanotube composition and later fabricating such material into a finished structure. For example, composite laminates contain fibrous reinforcement and resin. The materials comprising the fibrous reinforcement are coated with the carbon-nanotube composition during the manufacture of the fibrous reinforcement. For example, common reinforcements include fiberglass, carbon fiber and Kevlar. Typically, such reinforcements are either available in pure unidirectional fiber form, as a veil mat or as a woven fabric. Also, fiberglass is offered in a pressed, chopped, strand mat. Each of the reinforcing materials can be mixed with or coated with carbon-nanotube material during its formation. Thereafter, when the reinforcing material is used with resin to form a composite, the finished composite is integrally formed with carbon-nanotube material therethrough. Thereafter, electrodes can be connected, and after electric current is applied the composite material will generate heat. By utilizing reinforcing material that has been coated or mixed with carbon-nanotube material selectively in a mold, after formation certain portions of the composite will be heat generating. For example, if a boat hull were molded from reinforced fiberglass, selective portions of the reinforcement will utilize carbon-nanotube materials. There-after, when electrical current is applied to the molded hull, those portions having the nanotube material will generate heat. Such selective molding is useful to enable portions of the hull, such as the living space, to generate heat.

A heating element 200, 300, 400, 500 may be at least partially formed on a liquid and/or gas heater tank and/or associated piping by spraying a carbon nanotube/epoxy solution onto a fabric as described herein and within the patents and patent applications that are incorporated herein by reference. The resulting heating element 200, 300, 400, 500 may be on an outside of the tank and/or piping, an inside surface of the tank and/or piping, or may be sandwiched between two or more pieces of the tank and/or piping.

Although exemplary embodiments of the invention have been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A heated reinforcement bar, comprising:
a laminate heating element that includes nanoparticles; and
a positive electrical connection and a negative electrical connection, wherein the positive electrical connection and the negative electrical connection are configured to connect the nanoparticles to an electric power source.

2. The heated reinforcement bar of claim 1, further comprising:
a resilient connection connecting the ends of the element together and serving to bias the element around the reinforcement bar.

3. The heated reinforcement bar of claim 1, further comprising:
a corrosion protective anode, for reducing deterioration of the anode.

4. The heated reinforcement bar of claim 3, wherein the corrosion protective anode includes a looped electric resistor, a resistor electric insulating layer surrounding said electric resistor, a metallic sheath surrounding said resistor insulating layer, said sheath having an exterior surface of nickel, a sheath electric insulating layer of polytetrafluoroethylene covering said nickel surface and adhering thereto, electric connections to the two ends of the electric resistor, and an insulating support for the electric connections.

5. The heated reinforcement bar of claim 4, in which said sheath is of copper, having an exterior layer of nickel plated thereon.

6. The heated reinforcement bar of claim 5, in which the exterior surface of said nickel surface has a matte finish.

7. A laminate heating element, comprising:
a heat generating portion having nanoparticles deposited on a first surface of a substrate and a pressure sensitive adhesive on a second surface of the substrate; and
a positive electrical connection and a negative electrical connection, wherein the positive electrical connection and the negative electrical connection are configured to connect the nanoparticles to an electric power source.

8. The laminate heating element of claim 7, further comprising:
an inert material that isolates the multi-wall carbon nanotubes and the polymer from the electrolyte.

9. The laminate heating element of claim 8, wherein the inert material is thermally conductive.

10. The laminate heating element of claim 7, further comprising:
a thermally insulating material that insulates the nanoparticle composite heating element from an ambient environment surrounding the laminate heating element.

11. The laminate heating element of claim 7, further comprising:
a thermally conducting material proximate the nanoparticle composite heating element.

12. The laminate heating element of claim 7, further comprising:
a temperature control circuit electrically connected to the nanoparticle composite heating element to automatically control a temperature of the laminate heating element.

13. A heated reinforcement bar, comprising:
a heating element that includes nanoparticles; and
a positive electrical connection and a negative electrical connection, wherein the positive electrical connection and the negative electrical connection are configured to connect the nanoparticles to an electric power source.

14. The heated reinforcement bar of claim 13, further comprising:
an inert material that isolates the multi-wall carbon nanotubes and the polymer from the electrolyte.

15. The heated reinforcement bar of claim 14, wherein the inert material is thermally conductive.

16. The heated reinforcement bar of claim 13, further comprising:
a thermally insulating material that insulates the nanoparticle composite heating element from an ambient environment surrounding the heated reinforcement bar.

17. The heated reinforcement bar of claim 13, further comprising:
a thermally conducting material proximate the nanoparticle composite heating element.

18. The heated reinforcement bar of claim 13, further comprising:
a temperature control circuit electrically connected to the nanoparticle composite heating element to automatically control a temperature of the heated reinforcement bar.

19. The heated reinforcement bar of claim 13, further comprising:
an armored layer surrounding the heated reinforcement bar.

20. The heated reinforcement bar of claim 13, further comprising:
an adhesive layer.
